(19) United States
(12) Patent Application Publication
(10) Pub. No.: US 2021/0078902 A1
(43) Pub. Date: Mar. 18, 2021

(54) PORTLAND CEMENT MANUFACTURE USING MUNICIPAL SOLID WASTE INCINERATION ASH

(71) Applicant: University of Florida Research Foundation, Inc., Gainesville, FL (US)

(72) Inventors: Christopher C. Ferraro, Gainesville, FL (US); Timothy G. Townsend, Gainesville, FL (US); Kyle A. Clavier, Gainesville, FL (US)

(21) Appl. No.: 17/025,205

(22) Filed: Sep. 18, 2020

Related U.S. Application Data
(60) Provisional application No. 62/901,852, filed on Sep. 18, 2019.

(51) Int. Cl. C04B 7/44; C04B 7/42; C04B 7/02; C04B 7/52; C04B 28/14; F27B 3/18; F27B 3/24

(52) U.S. Cl. CPC C04B 7/4423; C04B 7/421; C04B 7/02; C04B 2111/00206; C04B 28/14; F27B 3/18; F27B 3/24; C04B 7/52

(57) ABSTRACT

Various examples related to portland cement manufacturing using municipal solid waste incineration (MSWI) ash are provided. In one example, a method includes providing a raw kiln feed including MSWI to a kiln, forming ash-amended clinker (ACK) by heating the raw kiln feed in the kiln, and preparing ash-amended cement (AAC) from the ACK. The MSWI bottom ash can make up about 5% by mass or less of the raw kiln feed. The ACK can have a chemical composition that meets ASTM C150/ASTM C595, and the AAC can include arsenic, barium, copper, and lead consistent with defined Soil Cleanup Target Levels. In another example, a system includes a kiln, a kiln feed system that supplies raw kiln feed including MSWI bottom ash to the kiln, and a finish mill that grinds ACK formed by heating the raw kiln feed in the kiln to form AAC.

### CROSS REFERENCE TO RELATED APPLICATIONS

This application claims priority to, and the benefit of, co-pending U.S. provisional application entitled “Portland Cement Manufacture Using Municipal Solid Waste Incineration Ash” having Ser. No. 62/901,852, filed Sep. 18, 2019, which is hereby incorporated by reference in its entirety.

### BACKGROUND

With Municipal solid waste (MSW) generation in the United States (US) increased to over 230 million Mg in 2015, reducing the volume of the waste that must be disposed of in landfills is becoming an increasingly important. Municipal solid waste incineration (MSWI) for energy and material recovery has become an outlet to achieve this goal. However, MSWI ash is a remnant borne from the combustion process and must be managed appropriately. Byproducts in MSWI ash comprise fine fly ash, often laden with heavy metals, chlorides, and alkalis, which is captured by the air pollution control equipment, and bottom ash (BA) which is typically coarser material remaining in the boiler after combustion. In the US, facility operators typically commingle MSWI BA and fly ash for disposal in a lined landfill.

### SUMMARY

Aspects of the present disclosure are related to portland cement manufacturing using municipal solid waste incineration (MSWI) ash. In one aspect, among others, a method comprises providing a raw kiln feed to an industrial cement production kiln, the raw kiln feed comprising municipal solid waste incineration (MSWI) bottom ash from a refuse derived fuel, where the MSWI bottom ash makes up about 5% by mass or less of the raw kiln feed; forming ash-amended clinker (ACK) by heating the raw kiln feed in the industrial cement production kiln; and preparing ash-amended cement (AAC) from the ACK formed in the industrial cement production kiln. In one or more aspects, the MSWI bottom ash can be subjected to a metals recovery process for recovery of ferrous and non-ferrous metals. The MSWI bottom ash can be filtered to remove large particles.

In various aspects, the industrial cement production kiln can be a dry process kiln. The raw kiln feed can comprise a combination of coal ash, bauxite ore, iron slag, limestone, sand and the MSWI bottom ash. The ACK can comprise a chemical composition for the formation of portland cement that meets ASTM C150/ASTM C595. The AAC can be prepared from the ACK using a finish mill with addition of gypsum. The raw kiln feed can comprise about 5% by mass of the MSWI bottom ash or about 2.8% by mass of the MSWI bottom ash. The AAC can comprise arsenic (As), barium (Ba), copper (Cu), and lead (Pb) consistent with defined Soil Cleanup Target Levels (SCTL). The MSWI bottom ash can comprise unwashed MSWI bottom ash.

In another aspect, a system comprises an industrial cement production kiln; a kiln feed system that supplies raw kiln feed comprising municipal solid waste incineration (MSWI) bottom ash from a refuse derived fuel to the industrial cement production kiln, where the MSWI bottom ash makes up about 5% by mass or less of the raw kiln feed; and a finish mill that grinds ash-amended clinker (ACK) formed by heating the raw kiln feed in the industrial cement production kiln to form ash-amended cement (AAC). In one or more aspects, the AAC can be formed from the ACK by the finish mill with addition of gypsum. The industrial cement production kiln can be a dry process kiln. The ACK from the industrial cement production kiln can be cooled prior to grinding by the finish mill.

In various aspects, the raw kiln feed can comprise a combination of coal ash, bauxite ore, iron slag, limestone, sand and MSWI bottom ash. The MSWI bottom ash can be subjected to a metals recovery process for recovery of ferrous and non-ferrous metals prior to being added to the raw kiln feed. The MSWI bottom ash can be filtered to remove large particles. The MSWI bottom ash can comprise unwashed MSWI bottom ash. The ACK can comprise a chemical composition for the formation of portland cement that meets ASTM C150/ASTM C595. The AAC can comprise arsenic (As), barium (Ba), copper (Cu), and lead (Pb) consistent with defined Soil Cleanup Target Levels (SCTL).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram illustrating an example of a kiln for a dry kiln process, in accordance with various embodiments of the present disclosure.

FIG. 2 is a table illustrating examples of Toxicity Characteristic Leaching Procedure (TCLP) extract concentrations of bottom ash (BA) samples, in accordance with various embodiments of the present disclosure.

FIGS. 3A-3D illustrate examples of element concentrations found in control and MSWI ash-amended cement (AAC) samples, in accordance with various embodiments of the present disclosure.

FIGS. 4-6 illustrate examples of leaching from control and MSWI AAC samples, in accordance with various embodiments of the present disclosure.

FIGS. 7A and 7B illustrate examples of x-ray diffraction (XRD) patterns for control and MSWI AAC samples, in accordance with various embodiments of the present disclosure.

FIG. 8 is a table illustrating examples of quantitative x-ray diffraction (QXRD) results for control and MSWI AAC samples, in accordance with various embodiments of the present disclosure.

FIGS. 9A and 9B illustrate examples of instantaneous and cumulative heat generation by isothermal calorimetry for AAC and control (OPC) specimens, in accordance with various embodiments of the present disclosure.

FIG. 10 illustrates an example of compressive strength for control and MSWI AAC samples, in accordance with various embodiments of the present disclosure.

### DETAILED DESCRIPTION

Disclosed herein are various examples related to portland cement manufacturing using municipal solid waste incineration (MSWI) ash. Reference will now be made in detail to the description of the embodiments as illustrated in the drawings, wherein like reference numbers indicate like parts throughout the several views.

While several potential reuse options have been identified (road base, concrete and pavement aggregate), MSWI ash recycling has received only limited attention in the US. A pathway toward the expansion of MSWI ash recycling in the US can be realized through using this material as a raw material for cement production. Due to the sheer magnitude of cement production globally (over 2.5 billion metric tons annually and trending upward), research surrounding this beneficial use application shows promise with considerable upside. Such a recycling initiative can be quite substantial. Even when used in small percentages, the replacement of raw kiln feed with MSWI ash acts as a significant sink for material due to the scale of the portland cement industry. Integrating MSWI ash into cement production also has the potential to mitigate some of the potential environmental impacts associated with the other methods of beneficially using this byproduct. To date, only limited research has examined using MSWI ash (both bottom and fly ash) as a cement kiln feed.

Barriers to implementation of MSWI ash as cement kiln feed in the US include uncertainties with respect to the environmental risk and end product performance, as MSWI ash addition has been demonstrated to have a deleterious impact on these outcomes when used to replace cement kiln feed at large addition rates. Research has shown that ash incorporation into cement production may be associated with a decrease in the mechanical strength, increased leaching of constituents of potential concern, and changes to cement mineralogy and hydration as well as reactivity characteristics. Although most trace elements of environmental concern in the ash should be stabilized within the matrix of a cement-based product, there may be potential for these chemicals to leach when reused or disposed of in the future. MSWI ash is composed of elements needed for cement production (Ca, Si, Fe, Al), but other constituents such as chlorides, alkalis, and trace metals may alter the hydration and reactivity properties of cement and the mechanical strength of the cement products. Studies that have utilized MSWI ash as cement kiln feed have centered on laboratory-scale experiments, utilizing a high temperature oven to create clinker. Ground, sieved, and homogenized MSWI bottom ash (BA) has been used with a traditional raw mix at different replacement percentages (3%, 10%, and 15%); where the mix was heated to a temperature of approximately 1500 C and then ground and blended with sand and water to create a mortar for compressive strength testing. Pelletized clinkers resulted in mortar specimens that exceeded compressive strength standards, but when ash was incorporated beyond 5% of the total raw mix a noticeable decline in the compressive strength was observed.

Studies have used MSWI fly ash to replace cement raw mix. When heated at a max temperature of 1300 C it was found that up to a 30% replacement with MSWI fly ash may be feasible but increasing ash addition had a negative impact on compressive strength. The clinkers helped reduce heavy metal leaching, but the high presence of chlorides and alkalis potentially increased volatility of elements that may form salts with these compounds and cause issues with a cement kiln. MSWI BA was also incorporated at 5% and 10% replacement of raw feed and heated to 1450 C to form clinker. Increasing the ash addition resulted in a decrease in compressive strength, an increase in setting time, and lower flow values.

It has been found that clinker made with up to an 8% replacement of MSWI BA and fly ash in a muffle furnace at 1400 C exhibited typical phase compositions of normal portland cement and leached below regulatory limits. The presence of alkalis enhanced hydration, but a heavy metal content may retard the hydration rate. It was found that incorporation of up to 6% MSWI fly ash produced a clinker with an appropriate composition, but that fly ash clinkers can have difficulties forming alite phases due to the lack of CaO, and that heavy metals were reported as stabilized in the clinker.

Pilot-scale studies using larger kilns are comparatively lacking. A 50 ton per day pilot test was conducted to incorporate MSWI ash in cement clinker production at up to 40.6% by weight replacement of traditional raw feed. The time of set for the ash-amended clinkers was shorter than the control cement, but compressive strength was unaffected, and leached metal concentrations were reported to be of no concern, even though the ash-amended mixes had high amounts of leached chloride. Approximately 1% of raw kiln feed was replaced with MSWI fly ash in a 3 day, 30 tons of ash per day trial, and it was found that setting times and compressive strength had only a slight negative correlation with MSWI ash addition. The clinker was well within specification of a control clinker and leaching tests showed no excess leaching of heavy metals associated with MSWI fly ash incorporation. While investigating co-processing of MSWI fly ash in a cement kiln at full production scale of approximately 110 tons per hour clinker production, it was found that addition of dried and washed fly ash at less than 2% of the raw mix showed increases in Cd, Pb, and Sb content in clinker, and that the MSWI fly ash additions correlated with increased stack emissions of Hg.

While a few studies have been conducted, knowledge gaps remain regarding MSWI ash incorporation into cement production, especially in the US context. First, most studies on MSWI ash-amended cement examine the use of MSWI fly ash, not MSWI BA. A likely first step for MSWI ash recycling into US cement production would be BA, because of the perceived risk associated with heavy metal and chloride leaching from fly ash. Laboratory-scale studies exploring MSWI ash as kiln feed far outnumber full-scale or pilot-scale studies; among other things, pilot-scale or full-scale studies are needed to assess the outcomes of all of the complex chemical and physical interactions that MSWI ash may have in the cement kiln on an industrial scale, something that lab scale studies cannot account for. Most studies focus on either performance or environmental risk of MSWI ash-amended cement, but seldom both. And again, ash composition may vary dramatically based on locality, and existing studies are geographically focused in Asia and occasionally in Europe, demonstrating a need for full-scale examination in North America.

This disclosure provides support for MSWI BA-amended cement production in North America, assisting in the navigation of a complex technical and regulatory pathway to create a new recycling market for MSWI BA. With a full-scale kiln experiment with MSWI ash use as a feedstock, the results can provide a novel insight into the feasibility of MSWI BA use as a cement kiln feed.

Materials and Methods

In this disclosure, the applicability of MSWI BA from a US MSWI facility as a cement kiln feed was assessed through the use of environmental, chemical, and physical test methods. Cement was created in a full-scale kiln trial using a 2.8% replacement by mass of traditional kiln feed materials, sampled, and fabricated into concrete and mortar specimens. A hazardous waste characterization was performed, and total pollutant concentrations along with batch and monolithic leach test results were used to assess potential risk to human health and the environment associated with MSWI ash incorporation into cement. The chemical makeup and reactivity of the cement was also assessed with x-ray diffraction techniques, isothermal calorimetry, and time of set measurements. Structural performance was assessed through measurements of mortar cube compressive strength.

Bottom Ash Collection. BA was collected from a refuse derived fuel (RDF) MSWI facility using spreader stoker combustion technology in Florida, US. The samples were shipped from the MSWI facility to the cement kiln in 8-h per day shifts and stored in a covered, outdoor storage area until approximately 363,000 kg of BA was staged over the course of 5 days. As part of the RDF process, the wastes are sorted, shredded, and subjected to a metals recovery process for ferrous and non-ferrous metals. The MSWI ash is then subjected to additional ferrous and non-ferrous metals recovery before exiting the facility. Once delivered to the cement kiln staging area, ash was manually examined on a per-load basis for large pieces of metal and other debris, which if encountered, were removed. Eight grab samples were collected every hour in 19-L high-density polyethylene (HDPE) buckets to represent a daily composite sample. Samples were transferred to the laboratory and homogenized to produce a composite sample for hazardous waste characterization to provide a baseline assessment of hazardous waste status of the ash itself.

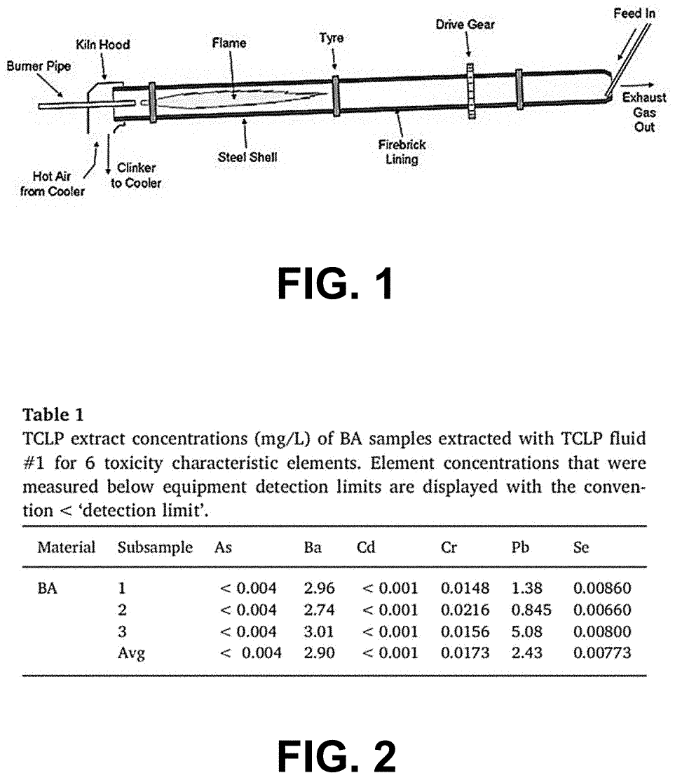

Cement Manufacture. A full-scale kiln test was performed whereby approximately 1,000 tons of ash-amended clinker (ACK) was produced over the course of several hours in a dry process kiln with a capacity of approximately 2 million Mg of cement per year. FIG. 1 illustrates an example of a kiln. The basic dry process comprises the kiln and a preheater. The raw materials, limestone and shale for example, are ground finely and blended to produce a raw meal. The raw meal is fed into the preheater, where hot gas from the kiln efficiently transfers heat to the raw meal. The meal then enters the kiln for the formation of clinker. Typical raw materials of mixed coal ash, bauxite ore, iron slag, and limestone were combined with MSWI BA in a proprietary clinker mix design that was proportioned based upon chemical composition of typical raw materials and desired clinker chemical composition for Type I/II cement that meets ASTM C150/ASTM C595. Other raw materials such as, e.g., clay, blast furnace slag and/or iron ore with appropriate proportions of Ca, Si, Fe, Al and/or other trace elements can also be used to manufacture clinker containing MSWI bottom ash. Overall BA replacement of raw materials to create ACK was 2.8% by mass. The amount of unwashed MSWI bottom ash can be in a range up to about 6.4% by mass, up to about 5% by mass, up to about 4% by mass, or up to about 3% by mass. The use of washed MSWI bottom ash allows for the use of higher percentages.

Clinker Collection. Samples of a control clinker (CCK) were collected in the weeks prior to the pilot test; CCK represents the clinker produced during normal operation at the kiln, without any MSWI ash amendment. MSWI BA-amended clinker (ACK) was collected directly from a clinker feed offshoot once the production process was stable to ensure that the clinker represents the designed ash-amended product. ACK collection was conducted at a point in the clinker handling system before the storage silos to avoid any issues with contamination from the control clinker. Approximately 50 kg of each clinker type were collected and homogenized to form a composite sample of both clinkers.

Cement Collection. ACK was created in the full-scale kiln trial described in the cement manufacture section above, and BA-amended clinker was stored in a dedicated ACK silo until used to manufacture cement via finish mill and addition of gypsum. After the creation of the ash-amended cement (AAC), approximately 500 kg of cement was collected by facility operators in HDPE buckets and transported to the laboratory for homogenization and testing.

Due to the proprietary information of the industrial partner, the control cement (OPC), representing normal cement with no MSWI ash addition, was created by compositing 3 separate commercially available Type I/II ordinary portland cement (OPC), which is a general purpose and moderate sulfate resistant cement, in equal parts by mass. All subsequent leaching and performance tests for control specimens were performed on concrete and mortar specimens created from this composite OPC. A composite of 3 Type I/II cements represent a close approximation of how any one Type I/II cement (with no MSWI BA) might perform.

Concrete and mortar sample preparation. Concrete specimens made using OPC and AAC were both mixed and cast in 10-cm-diameter by 20-cm-tall cylindrical molds according to American Society for Testing and Materials (ASTM) C192. Concrete specimens were allowed to set for 24 h in a room-temperature environment under ambient indoor humidity conditions, at which point they were demolded and placed in a moist curing room for a period of 7 days, in an area protected from dripping water to minimize leaching and generate a conservative estimate of element release. Subsequent to curing, the cylinders were removed from the moist curing room, crushed and size-reduced according to the size ranges needed by the leach testing methodology. To minimize exposure to the environment, the crushed concrete samples were contained in sealed plastic containers when not in use. Cylinders created for testing with EPA Method 1315 (monolithic tank leaching) were not crushed; in order to satisfy the liquid-to-surface area requirements of EPA Method 1315 with reasonably sized sample containers, the cylinders were instead cut in half using a concrete saw to create the test specimens. Cylinders that were used for EPA Method 1315 were not exposed to the moist curing environment and were prepared for leach testing after the 24-h ambient curing period.

Mortar specimens with OPC and AAC were created and mixed in accordance with ASTM C109. Mortar specimens for leaching tests were subjected to the exact same preparation protocol as the concrete specimens described above.

Environmental Testing. An array of tests was used to assess the mobility of trace elements in OPC and AAC cement and cement products. The BA samples were subjected to the Toxicity Characteristic Leaching Procedure (TCLP), which is the mandated leaching test for hazardous waste characterization in the US, to assess hazardous waste status of the BA. MSWI BA was rotated end over end in a sealed HDPE bottle at a 20:1 liquid to solid ratio (LS) with an acetic acid based extract meant to simulate landfill leachate. Although the BA was expected to be non-hazardous based on past performance testing, TCLP characterization would be expected by a cement manufacturing facility considering integrating MSWI ash.

Analysis of total environmentally available trace element concentrations of BA, CCK, ACK, OPC, AAC, and all cement products was performed using Method 3050 B with a finely size-reduced 1 g sample. Samples were subjected to a harsh acid digestion protocol and analyzed for total concentrations. Total concentrations were performed in three replicates.

Cement products fabricated using OPC and AAC were subjected to several leaching protocols. The Synthetic Precipitation Leaching Procedure (SPLP) (EPA Method 1312) mimics exposure to acid rain in the environment and was used because it is often employed in US beneficial use characterizations to quantify leaching risk for land applied candidate beneficial use materials, such as recycled concrete aggregate (RCA). Monolith tank leaching (EPA Method 1315) involves submersion of a complete cylindrical concrete specimen in water that is periodically drained, replaced, and sampled for elemental mass release from an uncrushed, monolithic form. Leaching as a function of LS (EPA Method 1316) is a reagent water extraction that measures leached concentrations from crushed materials at different LS. All leachates and digestions were analyzed via inductively couple plasma atomic emission spectroscopy (ICP-AES) (e.g., ThermoScientific iCAP 6200). All leaching tests were performed in triplicate for verification.

Performance evaluation. Concrete and mortar samples were examined to determine their physical and chemical characteristics using a series of tests. Quantitative x-ray diffraction (QXRD) was used to analyze and compare major mineral phases that exist in AAC and OPC according to the procedures defined in ASTM C1365. Isothermal calorimetry was performed according to ASTM C1702 to investigate early age heat generation from AAC and OPC; all samples were tested in duplicate. Mentioned previously, ASTM C109 was followed in order to measure the compressive strength of mortar by crushing fabricated mortar cubes made from OPC and AAC at ages of 1, 3, 7, and 28 days; mortar cubes were crushed in triplicate samples at each age. Time of set was performed according to ASTM C403, by calculating the force needed to push plungers of different diameters through a cube-shaped mortar specimen as it sets.

Environmental Characterization

Hazardous waste characterization. BA samples were subjected to the TCLP to establish a baseline hazardous waste characterization before being integrated into cement production; the TCLP is often used in the US to ensure a candidate beneficial use material is formally nonhazardous before consideration for recycling applications. All BA samples were extracted in triplicate with TCLP fluid #1. Results from TCLP extractions can be found in the table of FIG. 2, where inorganic toxicity characteristic elements are displayed. Shown are the TCLP extract concentrations (mg/L) of BA samples extracted with TCLP fluid #1 for six toxicity characteristic elements. Element concentrations that were measured below the equipment detection limits are displayed with the convention <‘detection limit’. Hg and Ag are not displayed, as generator knowledge has established that Hg and Ag are not hazardous waste leaching concerns as established by the TCLP.

Though one replicate had elevated levels of lead slightly exceeding the TC limit of 5.0 mg/L (5.08 mg/L), results from multiple replicates indicate that the BA used for the cement trial in this disclosure was non-hazardous with a triplicate average of 2.43 mg/L, below the TC limit. Additionally, TCLP extract concentrations of As and Cd were below equipment detection limits in all samples (<0.004 mg/L and <0.001 mg/L, respectively). The MSWI BA was not a hazardous waste.

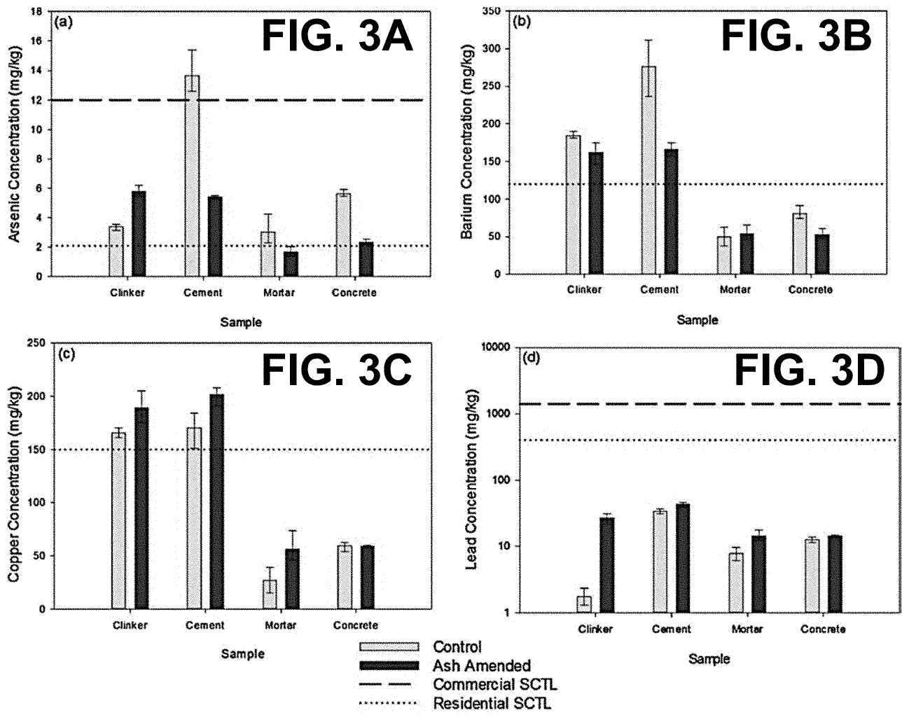

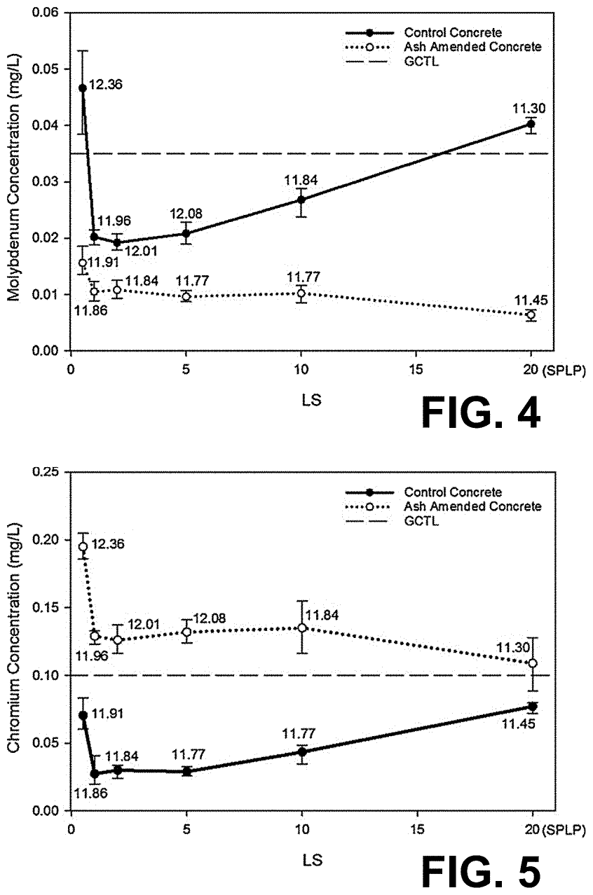

Total environmentally available concentrations. Total concentrations were compared to Florida (US) Soil Cleanup Target Levels (SCTL) to select constituents of potential concern for further analysis. The SCTL are risk-based thresholds normally used to assess direct exposure risk to contaminated soil or soil-like waste. It would not be appropriate for determining whether a cement or cement-based product would pose a risk or not. However, the SCTL do provide a convenient screening method for identifying chemicals that might be of most concern (from a direct exposure environmental perspective) if one day these products were removed and recycled. Residential SCTL represent an acceptable risk for soil exposure in a residential setting and are lower than the non-residential exposure setting represented by the commercial SCTL. FIGS. 3A-3D compares total concentrations for OPC and AAC specimens for arsenic (As), barium (Ba), copper (Cu), and lead (Pb), respectively. Residential (dotted line) and commercial (dashed line) thresholds for SCTL are indicated. Elements not discussed here are those with total concentrations substantially lower than the SCTL thresholds, and thus determined not to be of concern for these cements and cement products. Samples were measured in triplicate, and the error bars correspond to minimum and maximum concentrations of the three replicates.

Although As was present at elevated concentrations in the tested WTE BA (but similar to typical ash), the control cement sample was found to have a greater concentration of As than the ash-amended sample. The amount of ash added to the cement in the tests described here resulted in a substantial dilution. Other materials in the control cement kiln feed contributed much more As. It has been found that coal fly ash, which is a common kiln feed ingredient, exhibited As concentrations as high as 58.2 mg/kg, more than double the As concentration reported in this disclosure for BA. The high As concentration in coal fly ash could explain elevated arsenic concentrations found in the OPC replicates.

Similar results were obtained for Ba, Cu, and Pb. Although levels of these elements were somewhat elevated in the BA with respect to residential SCTL, the concentrations were similar to the control cement. This indicates that raw materials other than the BA are contributing to the elevated total metal concentrations. Concentrations of almost all elements in the ash-amended concrete were lower than the residential SCTL, with only arsenic being slightly higher (2.32 mg/kg vs. 2.1 mg/kg SCTL). But As levels were even higher in the control concrete specimens (5.65 mg/kg). Though the cement itself had total concentrations exceeding risk-based thresholds for As, Ba, and Cu (which again does not suggest that the cement presents a risk; as the SCTL comparison only provides a screening tool), incorporating the cement in concrete resulted in a considerable decrease in total concentration. There does not appear to be studies that compare MSWI BA-amended cement to a control on a total trace element concentration basis. Concentrations of As, Ba, Cu, and Pb are (unexpectedly) slightly higher in concrete samples than it is in mortar samples, which is counterintuitive when considering cement content of both samples. These samples, however, are of similar magnitude and differences are likely due to general sample variability. Elevated levels of As observed in BA are consistent with reported values for US bottom ash, average Cu concentration from this disclosure is greater than reported US values while Ba and Pb concentrations are lower than reported BA concentrations.

Batch leaching characterization. Crushed concrete specimens were subjected to EPA Method 1316 and the SPLP. In practice, recycled concrete is often crushed for use as an aggregate product at the end of its service life; these leaching tests were used to screen for risk from RCA leaching when land applied for road base or stabilizing material. Eluate concentrations at low LS provide insights into pore solution composition of low permeability materials such as a concrete specimen, or applications that may not be exposed to appreciable rates of infiltration, such as road base underneath a paved roadway. A wide variety of end uses for concrete samples exist that could encompass the whole range of LS tested. Therefore, a LS of 0.5-10.0 were examined to provide an expanded profile of leaching as a function of LS. Batch leaching tests are common way to characterize leaching risk in the literature regarding MSWI ash incorporation into cement. Researchers in previous studies have performed the TCLP, water extractions, and SPLP on ash-amended cement products.

FIGS. 4 and 5 display leached concentrations for control and ash-amended crushed concrete specimens exhibiting concentrations in excess of groundwater cleanup target levels (GCTL) in either leaching test. Elements not displayed are those with leached concentrations substantially lower than GCTL thresholds. Similar to the SCTL, Florida's (US) risk-based GCTL serve as a screening measure for identifying elements of potential risk if RCA was land applied. A true determination of risk would factor in other considerations, such as infiltration rate and soil and aquifer properties. Here, the GCTL add context to the side-by-side comparison of AAC and OPC products.

FIG. 4 illustrates an EPA Method 1316 and SPLP molybdenum (Mo) concentration comparison for control and ash-amended crushed concrete samples. A dashed line has been drawn at the Florida GCTL of 0.035 mg/L. Data for a LS of 20 represents SPLP extract concentrations. Concentrations at each LS are the average of triplicate measurements. Average extract pH is provided for each data point. Error bars are also provided corresponding to the minimum and maximum concentrations of each triplicate extraction. SPLP Mo concentrations exceeded the GCTL in the control samples (0.0403 mg/L vs 0.035 mg/L).

FIG. 5 illustrates an EPA Method 1316 and SPLP chromium (Cr) concentration comparison for control and ash-amended crushed concrete samples. A dashed line has been drawn at the Florida GCTL of 0.10 mg/L. Data for a LS of 20 represents SPLP extract concentrations. Concentrations at each LS are the average of triplicate measurements. Average extract pH is provided for each data point. Error bars are also provided corresponding to the minimum and maximum concentrations of each triplicate extraction. Cr concentrations exceeded the GCTL in the ash-amended samples (0.109 mg/L vs 0.1 mg/L). The Al exceeded in both samples (1.02 mg/L and 0.841 mg/L for control and ash-amended, respectively).

Overall, control and ash-amended cement products behaved similarly in regards to leaching as a function of LS, with some exceptions. At various LS reagent water extractions, results indicate some elevated concentrations across all samples. Control cement concrete specimens saw slightly elevated Mo and Sb at a LS of 5.0 (0.0466 mg/L vs 0.035 mg/L GCTL and 0.0130 mg/L vs 0.006 mg/L GCTL, respectively). Elevated Mo concentrations are consistent with the SPLP results as well, though elevated antimony found in EPA Method 1316 was not expected based upon SPLP extract concentrations. For AAC concrete specimens, however, Sb concentrations at LS of 1.0, 2.0 and 10.0 all showed in slight excess of the GCTL for antimony of 0.006 mg/L (0.0129 mg/L, 0.0072 mg/L, and 0.00870 mg/L, respectively). Cr was slightly elevated in ash-amended cement products across all LS tested (consistent with SPLP results). Similar elevated Cr concentrations were not observed in control specimens.

Control specimens exhibited elevated levels of Mo not seen in ash-amended products. Elevated Sb concentrations were similar for OPC and AAC concrete specimens, suggesting that both Sb and Mo were likely contributed by more materials than just BA. Elevated Cr concentrations were noted in AAC products that were not observed in the control specimens. Though pH has important implications for contaminant leaching, the trends observed for the same sample in FIGS. 4 and 5; pH variations for the same sample only varied by a maximum of approximately 0.5-1 standard units. Furthermore, differences in Cr and Mo leaching between samples may be attributed to differences in total Cr and Mo of the raw materials (higher Cr in AAC, higher Mo in OPC), as LS was the same value for each sample and the largest pH differences between samples at a given LS was only approximately 0.45 units.

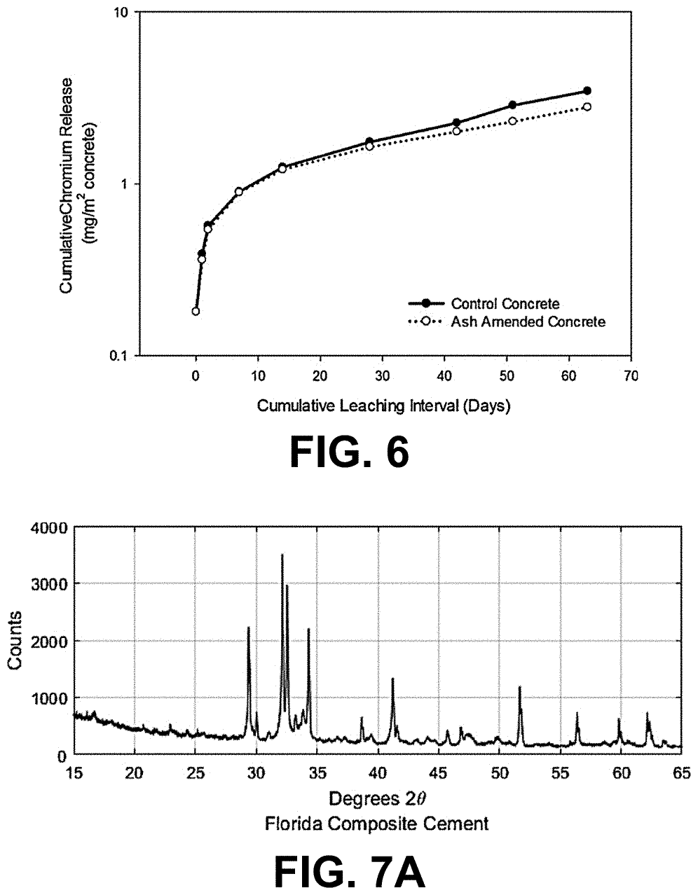

Monolithic leaching. To examine potential leaching from in-use, non-crushed concrete applications such as curbs or sidewalks, EPA Method 1315 was performed on monolithic concrete samples. Monolithic leaching studies on MSWI ash-amended cement products were similarly performed. Recall that total concentrations and batch leaching characterization indicate that As, Ba, Cu, Pb, Mo, Cr, Al, and Sb may be of potential concern when considering BA incorporation into cement production based upon exceedances of either the SCTL or GCTL. Of these elements, As, Cu, Pb, Mo all did not manifest concentrations above analytical detection limits over the entire 63-day testing interval for Method 1315, and are thus not provided here. Mass release graphs for Cr, Ba, and Al are displayed in FIG. 6. The EPA Method 1315 cumulative chromium mass release per square meter exposed concrete surface area is illustrated over the cumulative leaching time of 63 days. Concentrations at each leaching interval are the average of triplicate sample measurements. Element release is provided on a logarithmic scale.

Method 1315 gives an indication of element leaching in monolithic (not crushed) samples, and in these tests more elements were released in the control concrete than in the ash-amended concrete. Recall that Cr was the only element which had elevated concentrations in batch leaching tests. Method 1315 chromium concentrations are all much lower than those measured by SPLP. Method 1315 data found early-age chromium leaching from monolithic samples amended with AAC not to be an issue. This trend is consistent across constituents of potential concern, and many elements analyzed showed concentrations below analytical detection limits. The results of the environmental testing conducted in this research found that using MSWI BA at 2.8% replacement of traditional kiln feed did not result in appreciable elevated risk differences when compared to the control cement product. All elements of potential concern in AAC concrete products leached well below GCTL under monolithic conditions, and were not dramatically different than cement products made with the control cement. Though AAC concrete specimens have consistently shown higher leached Cr than control specimens, OPC specimens show marginally higher Cr mass release in the Method 1315 test. No appreciable amount of Cr was released from either monolithic sample, and concentrations were only slightly higher than the detection limit of the analytical equipment. Thus any differences (likely due to sample variability) due to a small amount of Cr release would be exaggerated by the fact that mass release for both samples was very close to the detection limit.

Performance

Cement manufacturing facilities strive to produce cement products that meet all necessary performance characteristics. Any new kiln feed ingredients would need to provide a comparable or better final product; cement manufacturers will not use MSWI BA as a new kiln feed if the cement produced does not meet necessary properties. Cement kiln operators have the ability to adjust raw mix design to allow integration of alternative feed streams as long as other facility and product needs are met. The presentation of performance data as follows is not intended to suggest that integration of MSWI BA at the levels used here will provide the same results at all kilns; the feed mix at all facilities will differ depending on feed material quality, desired product outcomes, and kiln operation. Rather, this data provides those interested in pursuing this approach preliminary information regarding potential differences in cement quality when MSWI BA is utilized as kiln feed, especially in the North American context.

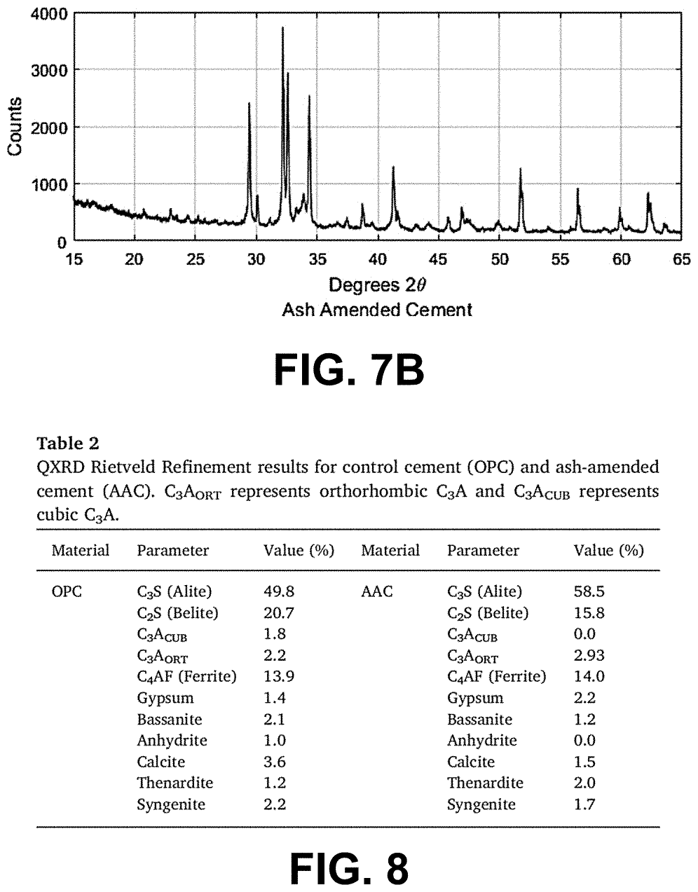

Quantitative x-ray diffraction. QXRD was performed to obtain the mineral phase content of both control OPC and AAC through Rietveld refinement. Samples were prepared using the backfill method, and the resulting patterns were refined using the open source PROFEX software package. Patterns from the two cements were refined using the same set of structure files. The patterns collected are shown in FIGS. 7A and 7B, while the table in FIG. 8 presents the mineral phase compositions of both OPC and AAC cements. FIG. 7A illustrates the XRD patterns for control composite OPC (Florida composite cement) and FIG. 7B illustrates the BA-amended AAC. The diffractograms appearing in FIGS. 7A and 7B are qualitatively very similar. Due to the extensive amount of peak overlap associated with portland cement diffractograms, qualitative assessment of differences between the two patterns is difficult. Rietveld refinement is utilized in this case to positively discern differences in phase composition of the two materials.

The collected diffractograms are both typical of Portland cement, with some subtle differences in peak height. However, more obvious differences between the samples are apparent in the mineral phase composition results. The most significant differences in composition are in the primary phases (C₃S, C₂S, C₃A, and C₄AF). The AAC contains approximately 10% more C₃S than the control. C₃S, or alite, is the phase primarily responsible for strength development and heat generation during the first 28 days of hydration. It is likely that the higher alite content of the AAC would result in more heat at early ages, faster setting times, and mortar or concrete with higher early age compressive strengths in comparison to the control cement.

Differences between the type of C₃A present in the two samples are also noted. C₃A, or aluminate, typically forms with a cubic crystal structure, however the presence of sodium during the clinkering of cement can result in orthorhombic C₃A. Cubic C₃A is highly reactive and in the absence of adequate gypsum results in a cement which can flash-set; and orthorhombic C₃A is more reactive still. The much higher proportion of orthorhombic C₃A in the AAC indicates proportionally elevated sodium levels in the raw mix. MSWI ash typically contains significant quantities of sodium, ranging as high as 17%, and is likely the primary contributor of sodium to the AAC.

Particle size analysis. Particle size analysis was performed on both cement samples prior to conducting isothermal calorimetry in order to rule out the effects of cement grinding on early age heat generation. Particle size is known to have significant effects on cement reactivity. Particle size analysis was performed using a Horiba LA-950 Laser Particle Analyzer. The specimens were dispersed in isopropanol alcohol and were subjected to 2 min of ultrasonic dispersion at 35 W of energy. The data indicate that the OPC has a slightly smaller median particle size (11.7 μm versus 12.4 μm for the AAC). Using a conversion routine the specific surface area (SSA), which approximates the surface area per unit mass, can be calculated using the equivalent spherical diameters obtained via laser particle size analysis. After converting to SSA, it was determined that the SSA of the AAC was approximately 5% higher than that of the control cement.

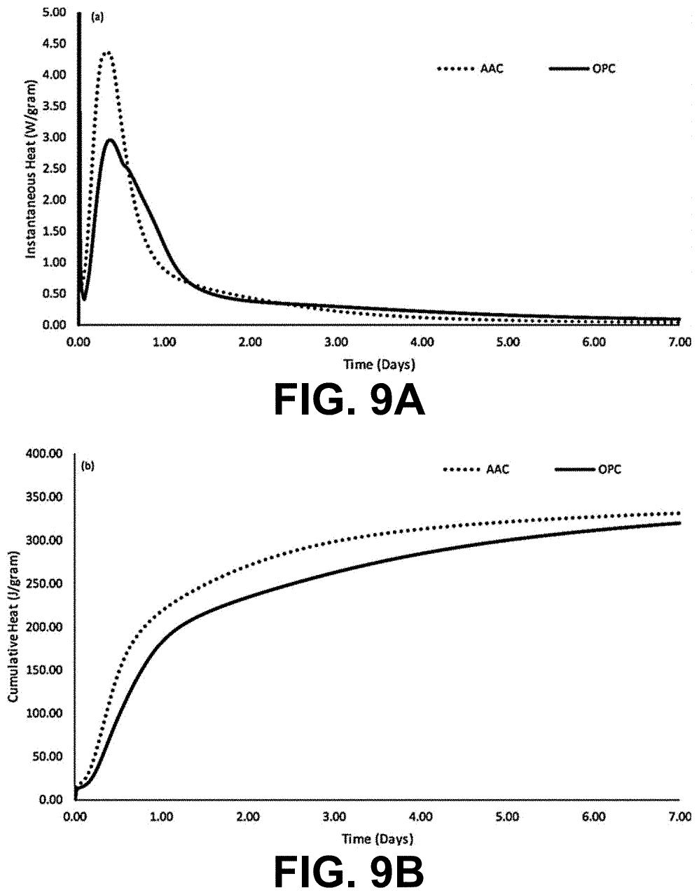

Isothermal calorimetry. Isothermal calorimetry was performed according to ASTM C1702 to compare the early age kinetics of the OPC control and AAC samples. The resulting power and heat evolution curves are presented in FIGS. 9A and 9B. FIG. 9A shows the instantaneous heat generation and FIG. 9B the cumulative heat generation by isothermal calorimetry for AAC and OPC specimens. The dotted lines represent the ash-amended cement and solid lines represent the control cement. Isothermal calorimetry was performed in duplicate and heat generation curves were exactly overlapping for each duplicate set. FIG. 9A illustrates differences in the duration and height of the peaks associated with hydration of C₃S after the dormant period. The two closely spaced peaks occurring between 6-10 h of age are higher for the AAC when compared to the OPC control. This may primarily be attributed to the higher alite and aluminate content in concert with the larger specific surface area (higher fineness) of the AAC. Salts like CaCl₂) which are typically present in elevated concentrations in MSWI ash increase early age heat generation associated with cement hydration. However, it is unlikely that the CaCl₂) present in MSWI ash remained in the material system subsequent to the clinkering process due to volatilization. Coupled with the minor replacement percentage of MSWI ash, the change to the observed hydration would be diminished. Accordingly, it is unlikely that soluble salt content was a major contributing factor for many of the observed differences in hydration behavior in this disclosure.

The cumulative heat production of the two cements is visualized in FIG. 9B. The AAC produces more heat cumulatively for the entire measurement period, although the slopes of the two curves at seven days indicate that the total heat generation may eventually converge. The greater heat production of the AAC may be evaluated for ambient conditions or other concrete structures where heat generation may be a concern.

Time of set. Ash-amended mortar reached the final set more quickly, approximately 250 min to final set, than the OPC specimens did, approximately 350 min to final set. This may indicate increased reactivity in the AAC. These results are consistent with previous industrial scale kiln trials that have reported that MSWI ash-amended cement clinkers produce setting times shorter than OPC, and are supported by the higher concentration of alite present in the AAC sample. However, laboratory-scale testing on MSWI fly and BA-amended cement have shown only slight increases in setting time when compared to control specimens. The increases in setting time could be attributed to presence of other metals such as Pb, Zn, or Cr.

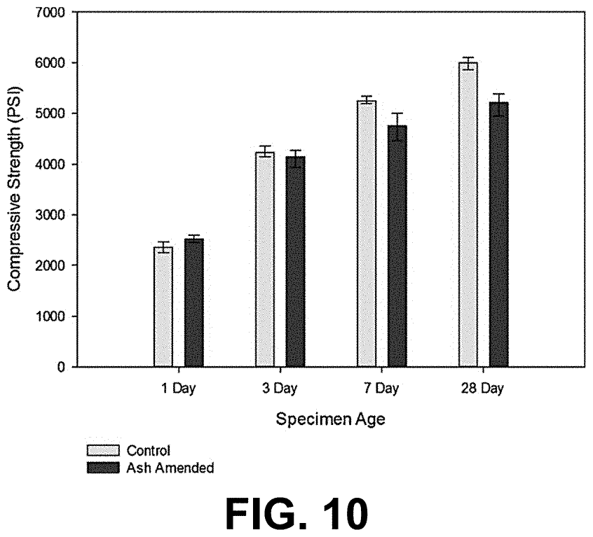

Mortar compressive strength. Mortar compressive strength was performed using ASTM C109 to assess differences in cement performance. FIG. 10 displays compressive strength of mortar cubes at 1, 3, 7, and a 28 days age. An example of the ASTM C109 mortar compressive strength as a function of specimen age is illustrated. All testing was performed in triplicate. AAC mortar specimens showed comparable early age strength development; while OPC ultimate strength was higher. Mortar samples were tested in triplicate. Error bars represent the minimum and maximum strengths of each triplicate measurement. Results indicate that 28-day mortar compressive strength for the specimens created from OPC is approximately 10% stronger than the specimens created with AAC. Though control specimens were stronger after 7 days of curing, early age strength slightly favored ash-amended specimens. This is consistent with the combined amount of alite and aluminate in the two specimens. More alite results in higher early strength but also a more porous microstructure due to the amount of soluble calcium hydroxide produced during hydration. This results in lower strength potential as curing progresses, particularly in a saturated curing environment such as that used for ASTM C109 mortar cube specimens.

Early age strength development favored AAC specimens, but ultimate compressive strength was higher in OPC specimens. Previous studies have reported that MSWI ash incorporation into cement production has a resultant compressive strength decrease but some have shown that low amounts of MSWI ash incorporation has negligible effects on compressive strength. Furthermore, it has been observed that cement and concrete systems which have higher early age reactivity tend to have lower compressive strength at ages of 28 days and beyond.

In summary, approximately 1,000 tons of MSWI BA-amended clinker, and eventual cement, was produced in a full-scale kiln trial that incorporated 2.8% by mass replacement of traditional feed materials with MSWI BA. This test is the first major exploration of MSWI ash recycling for cement production in the US, and helps fill the data gap pertaining to this recycling market in the US. Extensive physical, chemical, and environmental testing was used to assess the feasibility of incorporating MSWI BA into cement production as a kiln feed ingredient in place of traditional kiln feed components. Total concentrations, as well as batch and monolithic leaching tests on cement products (mortar and concrete), found no notable additional risk associated with MSWI BA addition. Elevated levels of total arsenic attributed to MSWI BA were lower than total arsenic concentrations seen in control samples and most total concentrations for other elements were approximately equal in both ash-amended and control cements. Leached chromium in batch leaching tests on AAC concrete specimens was only slightly above risk-based thresholds, but this concern was not observed with the monolithic leaching tests.

QXRD analysis indicates similar mineralogical phases between both cements, with increased alite formation in AAC that, in conjunction with higher fineness, may be responsible for increased early age reactivity. Sodium present in MSWI BA could also have impacted mineralogy formed during the clinkerization process. Early age strength development favored AAC specimens, but ultimate compressive strength was higher in OPC specimens.

Overall results support that industrial-scale beneficial use of MSWI BA should be feasible from a physical, chemical, and environmental perspective. The physical and environmental performance of the cement and cement products did not differ notably when MSWI BA was used at 2.8% kiln feed replacement. The incorporation of MSWI BA into portland cement production can offset significant amounts of landfilling, reduce mining for raw materials, and should result in cost savings for cement manufacturers and MSWI facility owners and operators. If the annual US clinker capacity of approximately 100 million metric tons is considered, a 2.8% replacement of traditional raw ingredients has the ability to offset mining and collection of 2.8 million metric tons of raw materials in favor of the use of incinerated waste in a cradle-to-cradle fashion. Beyond the environmental benefit gained from off-setting mining of traditional raw materials, the form of Ca in MSWI ash means that there is less CO₂ emissions associated with decarbonation of materials in the kiln (CaO in MSWI versus CaCO₃ in traditional calcium sources). Furthermore, other than ferrous and nonferrous metal recovery within the MSWI plant and the hand sorting of large pieces of materials, no significant pre-screening measures were taken to optimize the MSWI BA in this disclosure for use as kiln feed. Washing to remove chlorides and other soluble salts and advanced metals recovery are employed and result in a more desirable feed product. Implementation of such practices can result in MSWI BA products being even more suitable as kiln feed.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for portland cement manufacturing, comprising:
providing a raw kiln feed to an industrial cement production kiln, the raw kiln feed comprising municipal solid waste incineration (MSWI) bottom ash from a refuse derived fuel, where the MSWI bottom ash makes up about 5% by mass or less of the raw kiln feed;
forming ash-amended clinker (ACK) by heating the raw kiln feed in the industrial cement production kiln; and
preparing ash-amended cement (AAC) from the ACK formed in the industrial cement production kiln.

2. The method of claim 1, wherein the MSWI bottom ash is subjected to a metals recovery process for recovery of ferrous and non-ferrous metals.

3. The method of claim 2, wherein the MSWI bottom ash is filtered to remove large particles.

4. The method of claim 1, wherein the industrial cement production kiln is a dry process kiln.

5. The method of claim 1, wherein the raw kiln feed comprises a combination of coal ash, bauxite ore, iron slag, limestone, sand and the MSWI bottom ash.

6. The method of claim 1, wherein the ACK comprises a chemical composition for the formation of portland cement that meets ASTM C150/ASTM C595.

7. The method of claim 1, wherein the AAC is prepared from the ACK using a finish mill with addition of gypsum.

8. The method of claim 1, wherein the raw kiln feed comprises about 5% by mass of the MSWI bottom ash.

9. The method of claim 1, wherein the raw kiln feed comprises about 2.8% by mass of the MSWI bottom ash.

10. The method of claim 1, wherein the AAC comprises arsenic (As), barium (Ba), copper (Cu), and lead (Pb) consistent with defined Soil Cleanup Target Levels (SCTL).

11. The method of claim 1, wherein the MSWI bottom ash comprises unwashed MSWI bottom ash.

12. A system for portland cement manufacturing, the system comprising:
an industrial cement production kiln;
a kiln feed system that supplies raw kiln feed comprising municipal solid waste incineration (MSWI) bottom ash from a refuse derived fuel to the industrial cement production kiln, where the MSWI bottom ash makes up about 5% by mass or less of the raw kiln feed; and
a finish mill that grinds ash-amended clinker (ACK) formed by heating the raw kiln feed in the industrial cement production kiln to form ash-amended cement (AAC).

13. The system of claim 12, wherein the AAC is formed from the ACK by the finish mill with addition of gypsum.

14. The system of claim 12, wherein the industrial cement production kiln is a dry process kiln.

15. The system of claim 12, wherein the ACK from the industrial cement production kiln is cooled prior to grinding by the finish mill.

16. The system of claim 12, wherein the raw kiln feed comprises a combination of coal ash, bauxite ore, iron slag, limestone, sand and MSWI bottom ash.

17. The system of claim 12, wherein the MSWI bottom ash is subjected to a metals recovery process for recovery of ferrous and non-ferrous metals prior to being added to the raw kiln feed.

18. The system of claim 17, wherein the MSWI bottom ash is filtered to remove large particles.

19. The system of claim 12, wherein the MSWI bottom ash comprises unwashed MSWI bottom ash.

20. The system of claim 12, wherein the ACK comprises a chemical composition for the formation of portland cement that meets ASTM C150/ASTM C595.
